(19) United States
(12) Patent Application Publication
(10) Pub. No.: US 2012/0133304 A1
(43) Pub. Date: May 31, 2012

(54) DISCHARGE LAMP DEVICE

(75) Inventors: Naoki KITATOCHI, Himeji-shi (JP); Toshiya UKAI, Himeji-shi (JP); Toshiyuki OKAMOTO, Himeji-shi (JP); Takashi YAMASHITA, Himeji-shi (JP)

(73) Assignee: USHIO DENKI KABUSHIKI KAISHA, Tokyo (JP)

(21) Appl. No.: 13/251,633

(22) Filed: Oct. 3, 2011

(30) Foreign Application Priority Data
Nov. 26, 2010 (JP) 2010-263085

(51) Int. Cl. H05B 41/00

(52) U.S. Cl. 315/323

(57) ABSTRACT

A discharge lamp device comprising a high pressure discharge lamp having a discharge space and a pair of main electrodes in an interior of said discharge space, a starting assistance light source adapted to radiate UV radiation towards said discharge space, and a power supply device to light the high pressure discharge lamp and the starting assistance light source, wherein said starting assistance light source contains at least a rare gas for starting and carbon monoxide (CO) as a light emitting substance, and said power supply device is adapted to generate a high starting voltage at a time lighting of said high pressure discharge lamp is started and afterwards switch to a voltage for steady-state lighting, such that said starting assistance light source radiates by means of said high starting voltage but does not radiate by means of said voltage for steady-state lighting.

### BACKGROUND OF THE INVENTION

1. Field of the Invention

The present invention relates to discharge lamp devices used as light sources of projector devices or projectors, and relates specifically to discharge lamp devices provided with a UV cell assisting the starting of a high pressure discharge lamp.

2. Description of Related Art

For discharge lamp devices utilized in projector devices or projectors, devices are known in the art which comprise a high pressure discharge lamp as the light emitting source and a reflecting mirror arranged surrounding this discharge lamp, and further, devices are employed which comprise a starting assistance light source (in the following referred to as ‘UV cell’) to improve the starting properties of the high pressure discharge lamp.

JP-A-2009-117284 and corresponding U.S. Pat. No. 7,969,094 B2 disclose a configuration to mount said UV cell at a part of the discharge lamp or at a part of the concave-faced reflecting mirror. This UV cell contains e.g. mercury in the interior of a discharge vessel and emits UV light by employing a so called dielectric barrier discharge by means of external electrodes provided at the outside of the discharge vessel. By radiating the UV radiation emitted from the UV cell to the discharge space of the high pressure discharge lamp, said discharge space reaches a state in which a dielectric breakdown easily occurs. That means there is the result that the starting of the lighting of the high pressure discharge lamp is made easy. Therefore it suffices that the UV cell radiates only at the time of starting the discharge lamp, and it must be mounted not only at a position from which it can radiate UV radiation (UV) towards the discharge space at the time of starting the discharge lamp, but also at which it does not block the discharge light from said discharge lamp after the starting.

Recently, from the viewpoint of energy savings, there has been the demand to start the lighting of the discharge lamp with an even lower voltage. While, as an example, previously a starting voltage of 3 kV had been supplied, there is now the demand to start the lighting with 1 to 1.5 kV being at most half of the previous value. To meet this demand it is important to increase the energy of radiation from the UV cell.

The problem to be solved by this invention is to provide a discharge lamp device comprising a high pressure discharge lamp with a pair of main electrodes in the interior of a discharge space, a starting assistance light source (UV cell) radiating UV radiation towards said discharge space only at the time the lighting of the high pressure discharge lamp is started, and a power supply device to light the high pressure discharge lamp and the starting assistance light source, wherein the lighting of the discharge lamp can be started stably even with a low voltage.

### SUMMARY OF THE INVENTION

To solve the above-mentioned problem, the discharge lamp device according to this invention is characterized in that said power supply device is adapted to generate a high voltage for starting at the time the lighting of said high pressure discharge lamp is started and to switch to a voltage for steady-state lighting afterwards, said starting assistance light source (UV cell) radiates by means of said high voltage for starting but does not radiate by means of the voltage for steady-state lighting, and at least a rare gas for starting and carbon monoxide (CO) as a light emitting substance are contained in said starting assistance light source.

Because, according to the discharge lamp device of this invention, the UV cell only radiates at the time the lighting is started but does not radiate at the time of the steady-state lighting of the high pressure discharge lamp, the total lighting time of said UV cell is extremely short as compared to the lighting time of the discharge lamp and the problem of a blackening of the UV cell because of the CO has no adverse effect at all with regard to the practical application. Therefore, it is possible to use only the advantage that the energy of radiation of said UV cell is increased and the discharge lamp can be started with a low voltage.

### BRIEF DESCRIPTION OF DRAWINGS

FIG. 1 is a schematic overall sectional view of the discharge lamp device of the present invention.

FIG. 2 is a schematical view of the UV cell of the present invention.

FIG. 3 schematically shows an example for the power supply device according to the present invention.

### DETAILED DESCRIPTION OF THE INVENTION

As was mentioned above, the social demand to start the lighting of a discharge lamp device provided with a UV cell by means of a low voltage is to be met, and first, the inventors have turned their attention to the fact that the energy of radiation with a wavelength contributing to the dielectric breakdown at the time of starting the lighting of the discharge lamp is significantly larger as compared to an UV cell containing Hg (mercury), when CO (carbon monoxide) is contained as the light emitting substance of the UV cell. In this regard, as to lamps per se containing CO, a variety of such lamps has been suggested in the literature before (see, for example, JP-A-2002-358924). But when CO is enclosed in the light emitting tube, there is an extremely fast blackening of the discharge lamp. Therefore they are not employed in practical applications from the viewpoint of durability.

Now, the inventors of the present invention have found out that the blackening can be suppressed to a practically unproblematic level despite the content of CO, and the starting properties of the discharge lamp can be improved using a UV cell that radiates only at the time of starting of the discharge lamp. Then, as the result of assiduous investigations, the inventors of the present invention have come to use a configuration wherein the UV cell does not radiate at all at the time of the steady-state lighting of the discharge lamp, and they have further found a suitable CO content for the UV cell.

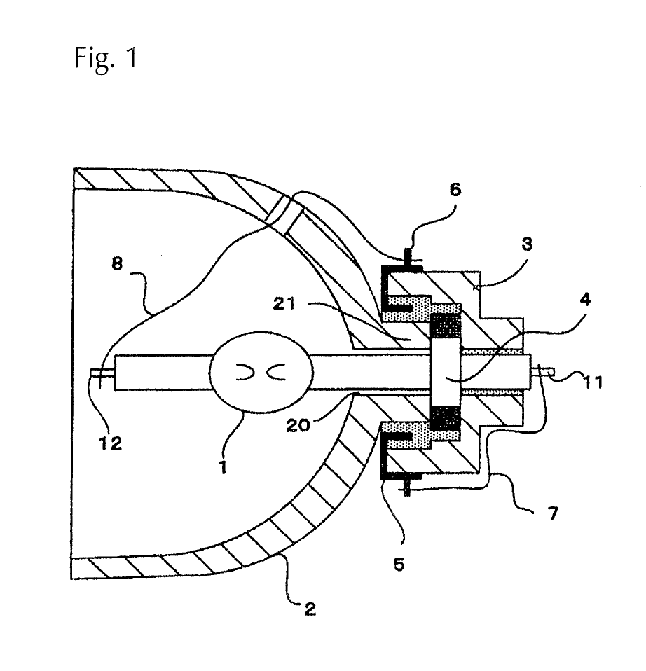

FIG. 1 shows a discharge lamp device of the present invention. The discharge lamp device comprises a discharge lamp 1, a concave-faced reflecting mirror 2 surrounding this discharge lamp 1, a base 3 fixed to the neck part 21 of this reflecting mirror 2, and a starting assistance light source (UV cell) 4 arranged in the base 3. One sealing portion of the discharge lamp 1 is inserted into a through hole 20 formed in the neck part 21 of the reflecting mirror 2 and is fixed at the base 3 by means of an adhesive. Further, a first power supply terminal 5 and a second power supply terminal 6 are fixed at said base 3. Sealing portions are formed at both ends of the light emitting tube of the discharge lamp 1, and external leads 11, 12 which are electrically connected to electrodes extend from these sealing portions and are connected electrically to the first power supply terminal 5 and the second power supply terminal 6 respectively via power supply wires 7, 8. One embodiment for the discharge lamp 1 is given below. In the interior of the light emitting tube of the discharge lamp 1, at least 0.15 mg/mm³ and for example 0.25 mg/mm³ of mercury are enclosed as the light emitting substance. Further, a halogen gas such as bromine is enclosed in an amount of 2.0·10⁻⁴ μmol/mm³ to 7.0·10⁻³ μmol/mm², for example 3.0·10⁻⁴ μmol/mm³, to prevent that tungsten being the constituent of the electrodes adheres to the inner wall of the light emitting tube, by means of the halogen cycle, and further approximately 13 kPa (100 Torr) of argon gas are contained. The maximum outer diameter of the light emitting tube of the discharge lamp 1 is 12.0 mm, the electrode spacing is 1.2 mm, the inner volume of the light emitting tube is 124 mm³, the bulb wall loading is 3.5 W/mm², the rated voltage is 85 V and the rated power is 330 W.

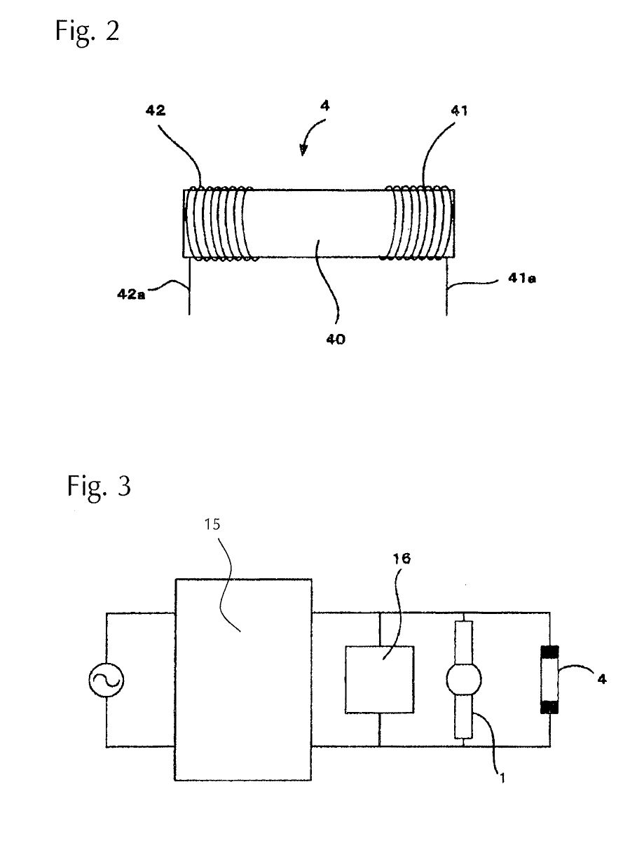

FIG. 2 shows the UV cell of the present invention. The UV cell 4 comprises a discharge vessel 40 made from quartz glass and a first external electrode 41 and a second external electrode 42 which are provided at the outer surface of both ends of this discharge vessel 40. Carbon monoxide (CO) is enclosed in the interior of the discharge vessel 40 as the light emitting substance. As to this carbon monoxide (CO), not only the enclosure of CO per se is possible, and there are also cases wherein carbon and oxygen or a carbon compound and an oxygen compound are contained separately and carbon monoxide is generated in the discharge vessel. Further, also a rare gas such as argon, xenon, neon or helium or a gas such as nitrogen may be contained. The amount of CO being contained is 0.1 to 5.0 Torr. In case of less than 0.1 Torr it is not possible to obtain sufficient UV radiation, while in case of more than 5.0 Torr the UV cell itself does not radiate. The enclosed rare gas preferably amounts to 10 to 30 Torr.

For the method to measure the enclosed amount of carbon monoxide, a nondestructive evaluation by spectral analysis for example by means of a method standardized by the spectral peak intensity of a rare gas such as argon is preferred.

Said first external electrode 41 and second external electrode 42 are formed by winding wires made from stainless steel or kanthal (an iron chrome alloy), being excellent with regard to thermal resistance and thermal shock resistance, in the longitudinal direction of the discharge vessel 40. It is also possible to attach wires having been formed coil-shaped previously as the first external electrode 41 and the second external electrode 42 at the discharge vessel 40. The discharge vessel 40 has, for example, an overall length of approximately 15 mm, an outer diameter of approximately 2.8 mm and a wall thickness of approximately 0.7 mm. The first external electrode 41 and the second external electrode 42 are formed coil-shaped with an overall length (in the longitudinal direction of the discharge vessel 40) of approximately 4 mm and an outer diameter of approximately 3 mm from a wire with a diameter of 0.3 mm. The electrode spacing is about 6 mm. In the interior of the discharge vessel 40, for example argon gas and carbon monoxide (CO) are enclosed.

Further, a first assistance light source power supply line 41a is connected to the first external electrode 41 of said UV cell 4 while a second assistance light source power supply line 42a is connected to the second external electrode 42. At the time of starting the discharge lamp 1 a voltage is applied to the first external electrode 41 and the second external electrode 42 via the first assistance light source power supply line 41a and the second assistance light source power supply line 42a and the light emitting substance in the interior of the UV cell 4 lights and UV rays are emitted. Then, to assist the discharge of the UV cell 4, for example a rod-shaped metal element may be enclosed in the interior of the discharge vessel 40. This metal element is, for example, made from molybdenum or tungsten.

Now, the gas types, the gas pressures, the electrode configuration etc. must be designed such that the UV cell 4 radiates by means of the high voltage being supplied at the time of starting the lighting of the high pressure discharge lamp 1 but definitely cannot radiate by means of the voltage being supplied during the steady-state lighting.

FIG. 3 shows an example for a power supply device according to the present invention. The high pressure discharge lamp 1 and the UV cell 4 are arranged in parallel in regard to a main lighting circuit 15. A trigger circuit 16 for starting is connected in series to the high pressure discharge lamp 1.

At the time of starting the lamp, said trigger circuit 16 generates a high voltage of for example, 1 to 1.5 kV. This high voltage is applied between the electrodes of the discharge lamp 1 and is similarly applied to the UV cell 4 being connected in parallel with the lamp 1. The UV cell 4 is configured such that it radiates by means of a high voltage of 1 to 1.5 kV, that is, by means of the operation of the trigger circuit 16, UV radiation is emitted from the UV cell 4.

When the dielectric breakdown of the discharge lamp 1 occurs, the trigger circuit 16 is switched off and a desired power (for example 330 W) is supplied from the main lighting circuit 15. By means of this the discharge lamp 1 switches to a stable lighting. As the UV cell 4, on the other hand, is configured such that it definitely does not radiate by means of this desired power, the lighting thereof stops at the same time as the operation of the trigger circuit 16 is stopped.

Next, embodiments will be explained to show the results of the present invention. The amount of the CO being enclosed in the UV cell 4 was altered and the lighting of the UV cell 4 per se as well as the lighting of the discharge lamp 1 were observed. Concretely, the application voltage to lamps 1 to 8 containing CO and, as a comparative example, a lamp 9 not containing CO was changed to 1.6 kV, 2.2 kV, 2.8 kV, 3.4 kV and 4.0 kV with a high frequency (40 kHz). The UV cell 4 was positioned at a distance of 50 mm from the lamp 1. An almost instant lighting of the UV cell 4 with the voltage application was marked ‘⊙’, a lighting, although not occurring instantly, was marked ‘◯’, and no lighting was marked ‘X’. The assessment of the occurrence of the lighting was done by observing visible light. Actually, not visible light but UV radiation is necessary, but as an emission of visible light means that also UV radiation is emitted, the emission of visible light was used for convenience for the assessment. As to the lighting of the lamp, a dielectric breakdown within 1 second from the voltage application was marked ‘⊙’, a dielectric breakdown within 2 seconds was marked ‘◯’, a dielectric breakdown within 3 seconds was marked ‘Δ’, and no dielectric breakdown was marked ‘X’.

In the experiment, devices such as described in the above mentioned embodiments were used for the UV cell 4 and the discharge lamp 1. More specifically, the CO content of the UV cell 4 of the respective lamps was as follows.
Lamp 1: 0.1 Torr CO, 0 mercury;
lamp 2: 0.4 Torr CO, 0 mercury;
lamp 3: 1.0 Torr CO, 0 mercury;
lamp 4: 1.0 Torr CO, 0.6 mg mercury;
lamp 5: 2.0 Torr CO, 0 mercury;
lamp 6: 4.0 Torr CO, 0 mercury;
lamp 7: 5.0 Torr CO, 0 mercury;
lamp 8: 6.0 Torr CO, 0 mercury;
lamp 9: 0 CO, 0.6 mg mercury.

The results of the experiment are shown in table 1.

TABLE 1

| | | UV cell | | | | | | | over- |
|---|---|---|---|---|---|---|---|---|---|
| | Item of | CO | Hg | application voltage (kV) | | | | | all |
| | evaluation | Torr | mg | 1.6 | 2.2 | 2.8 | 3.4 | 4.0 | rating |
| lamp 1 | UV cell | 0.1 | 0 | ⊙ | ⊙ | ⊙ | ⊙ | ⊙ | ◯ |
| | discharge lamp | | | Δ | Δ | ◯ | ⊙ | ⊙ | |
| lamp 2 | UV cell | 0.4 | 0 | ⊙ | ⊙ | ⊙ | ⊙ | ⊙ | ⊙ |
| | discharge lamp | | | ⊙ | ⊙ | ⊙ | ⊙ | ⊙ | |
| lamp 3 | UV cell | 1.0 | 0 | ⊙ | ⊙ | ⊙ | ⊙ | ⊙ | ⊙ |
| | discharge lamp | | | ⊙ | ⊙ | ⊙ | ⊙ | ⊙ | |
| lamp 4 | UV cell | 1.0 | 0.6 | ⊙ | ⊙ | ⊙ | ⊙ | ⊙ | ⊙ |
| | discharge lamp | | | ⊙ | ⊙ | ⊙ | ⊙ | ⊙ | |
| lamp 5 | UV cell | 2.0 | 0 | ⊙ | ⊙ | ⊙ | ⊙ | ⊙ | ⊙ |
| | discharge lamp | | | ⊙ | ⊙ | ⊙ | ⊙ | ⊙ | |
| lamp 6 | UV cell | 4.0 | 0 | Δ | Δ | ⊙ | ⊙ | ⊙ | ◯ |
| | discharge lamp | | | Δ | ◯ | ⊙ | ⊙ | ⊙ | |
| lamp 7 | UV cell | 5.0 | 0 | Δ | Δ | Δ | ⊙ | ⊙ | ◯ |
| | discharge lamp | | | Δ | Δ | ◯ | ⊙ | ⊙ | |
| lamp 8 | UV cell | 6.0 | 0 | X | Δ | Δ | ◯ | ◯ | Δ |
| | discharge lamp | | | X | Δ | Δ | ◯ | ◯ | |
| lamp 9 | UV cell | 0 | 0.6 | ⊙ | ⊙ | ⊙ | ⊙ | ⊙ | X |
| (compar. | discharge lamp | | | X | X | Δ | ◯ | ⊙ | |
| example) | | | | | | | | | |

As becomes clear from table 1 shown above, all lamps light with the known application voltage of 3 kV and more. The results are good when lamps light with a lower voltage of 2.2 kV and 1.6 kV. The CO content in their UV cells is 0.1 to 5.0 Torr.

Next, the method to enclose CO in the UV cell will be explained.

<Method to Enclose CO by Heating>

One end of the discharge vessel consisting of a quartz tube is sealed and a rod-shaped metal element from, for example, molybdenum is inserted into the interior of said discharge vessel. At this time it is also possible to introduce for example about 0.5 to 1 mg of mercury into the discharge vessel. Next, an evacuation to vacuum (for example 5·10⁻⁴ Torr) is performed by means of an evacuation device. Afterwards, argon gas is introduced in an amount of, for example, 20 Torr and the other end of the discharge vessel is sealed. When both end parts of the discharge vessel are sealed, this discharge vessel is heated for 20 minutes in the atmosphere at, for example, 1150° C. By means of such heating carbon and oxygen or carbon compounds and/or oxygen compounds are released from the quartz glass making up the discharge vessel into the discharge vessel and react when the UV cell radiates. Thus, carbon monoxide is generated. The quantity of generated carbon monoxide can be varied by adjustment of the heating temperature and the heating period during the heating process. Afterwards, the electrodes are attached to the outer surface of the discharge vessel.

### <Method of Enclosing by Means of Ethanol>

One end of the discharge vessel is sealed and a rod-shaped metal element from, for example, molybdenum is inserted into the interior of said discharge vessel. At this time it is also possible to introduce for example about 0.5 to 1 mg of mercury into the discharge vessel. Next, a small amount of ethanol of, for example 5 to 20 μl is introduced. Afterwards, an evacuation to vacuum (for example 5·10⁻⁴ Torr) is performed by means of an evacuation device, and further argon gas is introduced in an amount of, for example, 20 Torr and the discharge vessel is sealed. During the evacuation also the ethanol is evacuated, but ethanol also remains at the inner wall of the discharge vessel. This ethanol is split by means of the discharge when the UV cell radiates, and C and O₂ are formed. By a reaction of these CO is formed.

### <Method to Directly Enclose CO Gas>

One end of the discharge vessel is sealed and a rod-shaped metal element from, for example, molybdenum is inserted into the interior of said discharge vessel. At this time it is also possible to introduce for example about 0.5 to 1 mg of mercury into the discharge vessel. Next, an evacuation to vacuum (for example 5·10⁻⁴ Torr) is performed by means of an evacuation device, and afterwards, a mixed gas from argon gas and carbon monoxide (CO: 5%) is introduced in an amount of, for example, 20 Torr and the discharge vessel is sealed.

<Method of Enclosing by Introducing Carbon into the Metal Element>

One end of the discharge vessel is sealed and a rod-shaped metal element from, for example, molybdenum is inserted into the interior of said discharge vessel. Carbon is vapor-deposited onto this metal element. But if carbon is coated or the like onto the whole surface of the metal element, it has insulating properties and the function of assisting the discharge cannot be performed. Therefore, carbon is introduced into a part of the outer surface of the metal element only. Then, at this time it is also possible to introduce for example about 0.5 to 1 mg of mercury into the discharge vessel. Next, an evacuation to vacuum (for example 5·10⁻⁴ Torr) is performed by means of an evacuation device, and afterwards, argon gas is introduced in an amount of, for example, 20 Torr and the discharge vessel is sealed. With this configuration, H₂O being present in the UV cell is split by the discharge to H₂ and O₂, and this O₂ reacts with the C having been vapor-deposited on the metal element and CO is formed.

Because, as was described above, with the present invention the power supply device for lighting the high pressure discharge lamp and the starting assistance light source (UV cell) supplies a high voltage at the time the lighting of said lamp is started and then switches to a voltage for the steady-state lighting, the UV cell is configured such that it radiates by means of said high voltage for starting but does not radiate by means of the voltage for the steady-state lighting, and at least a rare gas for starting and carbon monoxide (CO) as a light emitting substance are enclosed in said UV cell, the problem of a blackening of the UV cell because of the CO has no adverse effect at all with regard to the practical application and only the advantage that the energy of radiation of said UV cell is increased and the discharge lamp can be started with a low voltage can be used.

What is claimed is:

1. A discharge lamp device comprising:
a high pressure discharge lamp having a discharge space and a pair of main electrodes in an interior of said discharge space,
a starting assistance light source adapted to radiate UV radiation towards said discharge space, and
a power supply device to light the high pressure discharge lamp and the starting assistance light source,
wherein said starting assistance light source contains at least a rare gas for starting and carbon monoxide (CO) as a light emitting substance, and
said power supply device is adapted to generate a high starting voltage at a time lighting of said high pressure discharge lamp is started and afterwards switch to a voltage for steady-state lighting, such that said starting assistance light source radiates by means of said high starting voltage but does not radiate by means of said voltage for steady-state lighting.

2. The discharge lamp device according to claim 1, wherein said starting assistance light source contains carbon monoxide (CO) in an amount of from 0.1 to 5.0 Torr.

3. The discharge lamp device according to claim 1, wherein said starting assistance light source has a vessel made of quartz glass, said carbon monoxide (CO) is generated from said vessel and the amount of carbon monoxide is adjusted by a heating temperature and heating time of said vessel during manufacture.

4. The discharge lamp device according to claim 1, wherein at least one of carbon, a carbon compound and an oxygen compound are enclosed in said starting assistance light source in order to form carbon monoxide, and a light emission by carbon monoxide (CO) is obtained by means of a discharge.

5. The discharge lamp device according to claim 1, wherein said power supply device is adapted to generate a high starting voltage in a range of from 1 to 2.2 kV.

6. The discharge lamp device according to claim 5, wherein said power supply device is adapted to generate a high starting voltage in a range of from 1 to 1.5 kV.
